(19) United States
(12) Patent Application Publication
(10) Pub. No.: US 2012/0122069 A1
(43) Pub. Date: May 17, 2012

(54) COACHS PLAY SYSTEMS

(76) Inventor: Fitzpatrick Coleman, Sharon Hill, PA (US)

(21) Appl. No.: 13/285,500

(22) Filed: Oct. 31, 2011

Related U.S. Application Data
(60) Provisional application No. 61/412,521, filed on Nov. 11, 2010.

(51) Int. Cl. G09B 25/00

(52) U.S. Cl. 434/365

(57) ABSTRACT

A visual coaching system for sports comprising a touch screen electronic device and a sports play application. The sports play application as used on touch screen electronic device allows coach-user to overlay a drawn play over a video such that the coach-user can review a previously played sports maneuver. The touch screen electronic device is usable to inform at least one assistant about at least one situation, with the coach-user being able to convey a message without moving. The sports play application allows the coach-user to stream and record live games such that the coach-coach-user can view replays. The touch screen electronic device as connected to a communicator provides an accessible network preferably enabling the coach-user to monitor live activities of player(s) and can send information from a first touch screen electronic device to at least an authorized second touch screen electronic device.

### CROSS-REFERENCE TO RELATED APPLICATION

The present application is related to and claims priority from prior provisional application Ser. No. 61/412,521, filed Nov. 11, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of sports and more specifically relates to a method and software application enabling a coach-user-coach to create and track sports plays for various sports.

2. Description of the Related Art

Many individuals in modern society play sports to maintain a level of fitness, for recreation or for a career. These athletes often require coaches to assist in their development. Currently, coaches must make use of a clipboard and pen or marker in order to draw out plays that they would like for their team to execute during a specified game. This process may take a significant amount of time to prepare and requires the coach to remember every single play that he or she has designed for the team. Another issue is that players may not always have the plays at hand to study them before a game. This can provide inconvenience to the coach, the team and the players. In competitive sports players and teams may need to use every possible advantage to win.

As mentioned, many coaches use clip boards. Although easy to write on, clip boards typically only allow for the players to see the plays executed one dimensionally, with no repeatability nor means whereby a coach can run through various plays as options in a short duration such as during a timeout. Computers may store a vast amount of information; however computers are not ready portable and are not suitably durable to withstand the rigors of athletic events and their inherent rough treatment during such events.

Various attempts have been made to solve the above-mentioned problems such as those found in U.S. Pub. And U.S. Pat. Nos. 2005/0196736; 2006/0281061; 2007/0143382; 6,931,290; 6,710,713; and 2007/0244878. This prior art is representative of coaching means. None of the above inventions and patents, taken either singly or in combination, is seen to describe the invention as claimed.

Ideally, a coach's play system should be user-friendly and, yet would operate reliably and be manufactured at a modest expense. Thus, a need exists for a reliable coach's play system, application and method to avoid the above-mentioned problems.

### BRIEF SUMMARY OF THE INVENTION

In view of the foregoing disadvantages inherent in the known coaching and sports art, the present invention provides a novel coach's play system. The general purpose of the present invention, which will be described subsequently in greater detail is to provide convenience of access to coaches and players during sporting events.

Coach's Play of the present invention comprises a software application which can be designed for touch screen devices and which may replace a coach's clipboard and adds many features which may make a coach's job simpler. This software application may allow coaches and players to create their own plays on the spot before a game, by using just the touch of a finger. This software application can be used by coaches in professional and amateur sports, including but not limited to basketball, football, soccer, lacrosse and many others. Any coach that is looking for a simple way to call up and execute plays on the spot can benefit from this software application. Coach's Play may be an application for iPad, iTouch, or other smart phones and may provide a handy tool for organizing and simulating offensive and defensive plays.

The present invention, coach's play system herein preferably comprises: a touch screen electronic device having a memory; and at least one sports play application. The memory provides that the coach-user is able to store and retrieve created-plays therefrom. The touch screen electronic device is portable and preferably hand-held. The touch screen electronic device in certain embodiments comprises an option that allows a coach-user to select between 1D, 2D and 3D mode(s) and allows the coach-user to save plays and show most-used-plays in ascending or descending order according to preference.

The sports play application as used on the touch screen electronic device allows a coach-user to overlay a drawn play over a video such that the coach-user can review a previously played sports maneuver. The sports maneuver comprises defensive-plays and offensive-plays. The coach-user when overlaying the drawn play over the video can see for example which player(s) was out of place in the previously played sports maneuver. Further, the touch screen electronic device comprises an option to draw plays for half and/or full court/field/track.

The sports play application preferably allows the coach-user to coordinate team color(s) and edit numbers of the players. The sports play application may further comprise an avatar similar to the players. The sports play application allows the coach-user to stream and record live games such that the coach-coach-user can view replays on-the-fly.

The touch screen electronic device as connected to a communicator (providing an accessible network) enables the coach-user to monitor live activities of players and can send information from a first said touch screen electronic device to at least a second touch screen electronic device such that other coaches may simultaneously analyze play. The touch screen electronic device is usable in this way to inform at least one assistant about at least one situation, the coach-user able to convey a message without moving. Additionally, the communicator providing the accessible network permits the user to receive the video via the accessible network. The communicator providing the accessible network permits the user to receive email via the accessible network such that two-way communications may occur with efficiency.

In accordance with the embodiments of the present invention a preferred method of use is disclosed herein comprising: activating a sports play application on a touch screen electronic device; capturing a sports maneuver; reviewing the played sports maneuver via drawing on the touch screen electronic device; analyzing the sports maneuver; and coaching at least one improvement on the sports maneuver. The method may further comprise the steps of accessing at least one email on the touch screen electronic device and/or accessing at least one downloadable sports video on the touch screen electronic device.

The present invention holds significant improvements and serves as a coach's play system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, coach's play system, constructed and operative according to the teachings of the present invention.

FIG. 1 shows a perspective view illustrating a touch screen electronic device and a sports play application in an in-use condition of a Coach's play system according to an embodiment of the present invention.

FIG. 2 is a perspective view illustrating the touch screen electronic device and a football specific sports play application according to an embodiment of the present invention of FIG. 1.

FIG. 3 is a perspective view illustrating the touch screen electronic device and a basketball specific sports play application using a full court option according to an embodiment of the present invention of FIG. 1.

FIG. 4 is a perspective view illustrating the touch screen electronic device and the basketball specific sports play application using a half court option and a drawn-on review according to an embodiment of the present invention of FIGS. 1 and 3.

FIG. 5 is a flowchart illustrating a method of using a coach's play system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a coaching device and more particularly to an application, system and method of coaching as used to improve visual coaching of athletes.

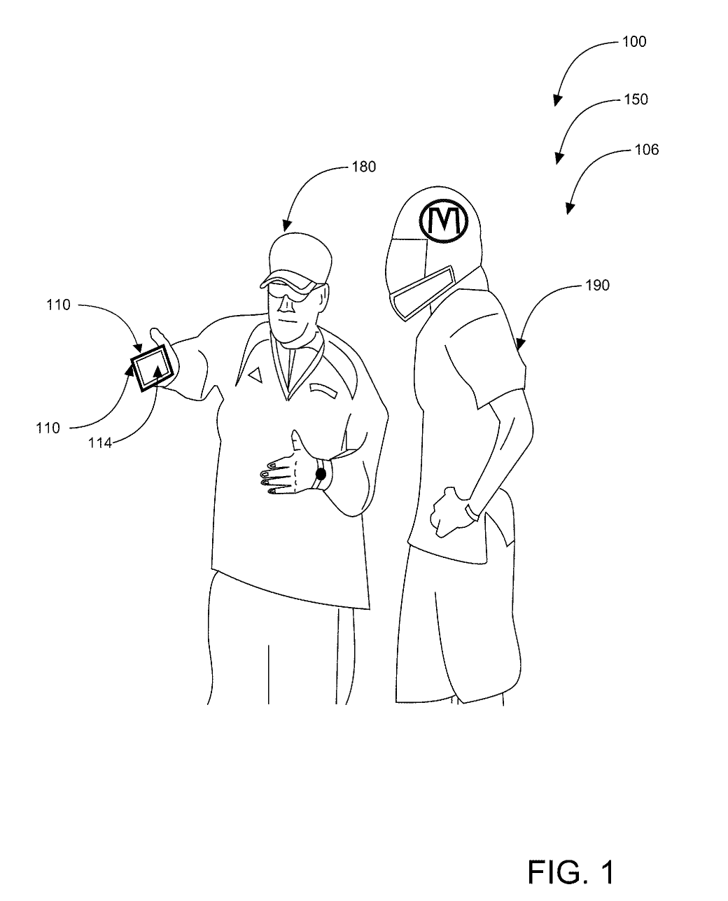

Referring to the drawings by numerals of reference there is shown in FIG. 1, a perspective view illustrating touch screen electronic device 110 and sports play application 130 in ‘in-use’ condition 106 of Coach's play system 100 according to an embodiment of the present invention.

Coach's play system 100 includes a visual coaching system for sports 102. Visual coaching system for sports 102 preferably comprises a software application which can be designed for touch screen electronic device 110 and which may replace a coach's clipboard and may add many features which may make a coach's job simpler. Visual coaching system for sports 102 may be used by coaches in professional and amateur sports, including but not limited to basketball, football, soccer, lacrosse and many others. Visual coaching system for sports 102 may allow coach-user 180 to create custom plays on the spot before a game, by using just the touch of a finger. Coach's play system 100 may comprise an OEM manufacture or be installed on an existing touch screen electronic device 110.

Visual coaching system for sports 102 preferably comprises touch screen electronic device 110; and sports play application 130. Touch screen electronic device 110 is preferably portable (handheld in preferred embodiments.) Sports play application 130 as used on touch screen electronic device 110 allows coach-user 180 to overlay a drawn play over a video such that coach-user 180 can review a previously played sports maneuver. Touch screen electronic device 110 is usable to inform at least one assistant about at least one situation, with coach-user 180 preferably being able to convey a message without moving. Sports play application 130 preferably allows coach-user 180 to stream and record live games such that coach-coach-user 180 can view replays. Furthermore, visual coaching system for sports 102 may have a section on the task bar that can be activated by touching a particular part on screen 114 of touch screen electronic device that both displays and activates the mentioned options (other options may also be available.)

Touch screen electronic device 110 preferably comprises an option that allows coach-user 180 to select between 1D, 2D and 3D mode(s). Touch screen electronic device 110 further comprises a memory wherein coach-user 180 is able to store and retrieve created-plays therefrom. Touch screen electronic device 110 as connected to a communicator (providing an accessible network) preferably enables coach-user 180 to monitor live activities of player(s) 190 and can send information from a first touch screen electronic device 110 to at least a second touch screen electronic device (not shown).

The communicator (providing the accessible network) preferably permits coach-user 180 to receive the video via the accessible network. The communicator providing the accessible network permits coach-user 180 to receive email via the accessible network. Upon reading this specification, it should be appreciated that, under appropriate circumstances, considering such issues as user preferences, design preference, structural requirements, marketing preferences, cost, available materials, technological advances, etc., other communicators for providing the accessible network such as, for example various wireless providers, etc., may be sufficient

Touch screen electronic device 110 may be used as an application for iPad, iPhone, iTouch, or other smart phones and may provide a handy tool for organizing and simulative offensive and defensive plays. Upon reading this specification, it should be appreciated that, under appropriate circumstances, considering such issues as user preferences, design preference, structural requirements, marketing preferences, cost, available materials, technological advances, etc., other electronic devices such as, for example, PDAs, Androids, etc., may be sufficient.

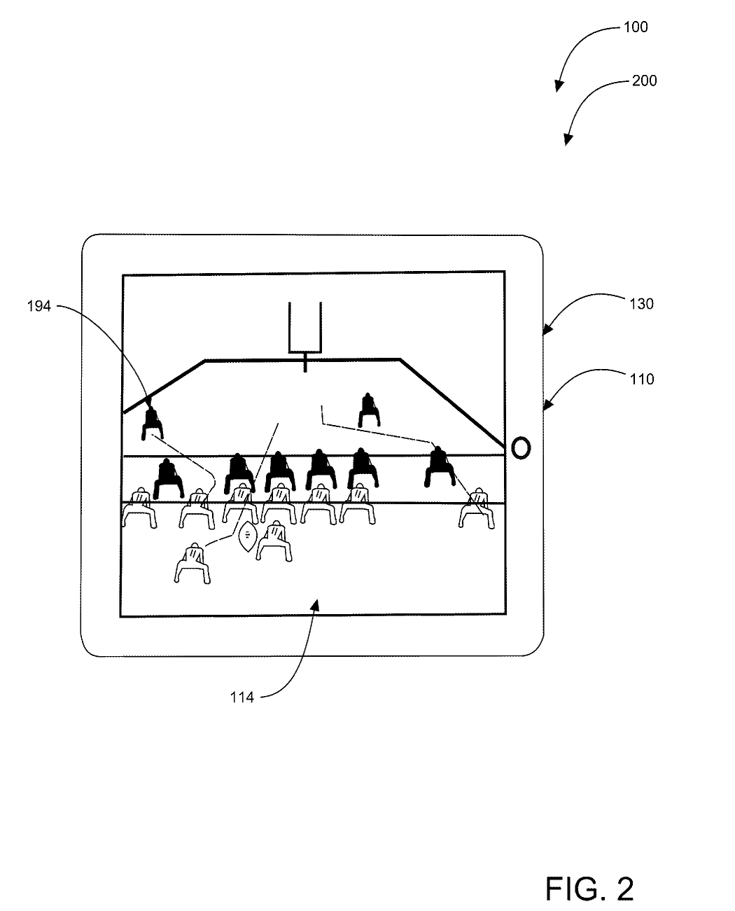

Referring now to FIG. 2-4, showing perspective views illustrating touch screen electronic device 110 and sports specific sports play application(s) 130 according to an embodiment of the present invention of FIG. 1.

When touch screen electronic device 110 is used for the sport of football 200 as shown in FIG. 2 the football specific sports play application 130 sports maneuver comprises either at least one defensive-play sports maneuver and/or at least one offensive-play sports maneuver. Sports play application 130 preferably allows coach-user 180 to coordinate team color(s) and edit numbers of players 190. Visual coaching system for sports 102 may further comprise avatar 194 similar to players 190 as shown best in FIG. 2. Upon reading this specification, it should be appreciated that, under appropriate circumstances, considering such issues as coach-user preferences, design preference, structural requirements, marketing preferences, cost, available materials, technological advances, etc., other options such as, for example, coloring of opposing teams, editing for injuries, playing assuming penalties, etc., may be sufficient.

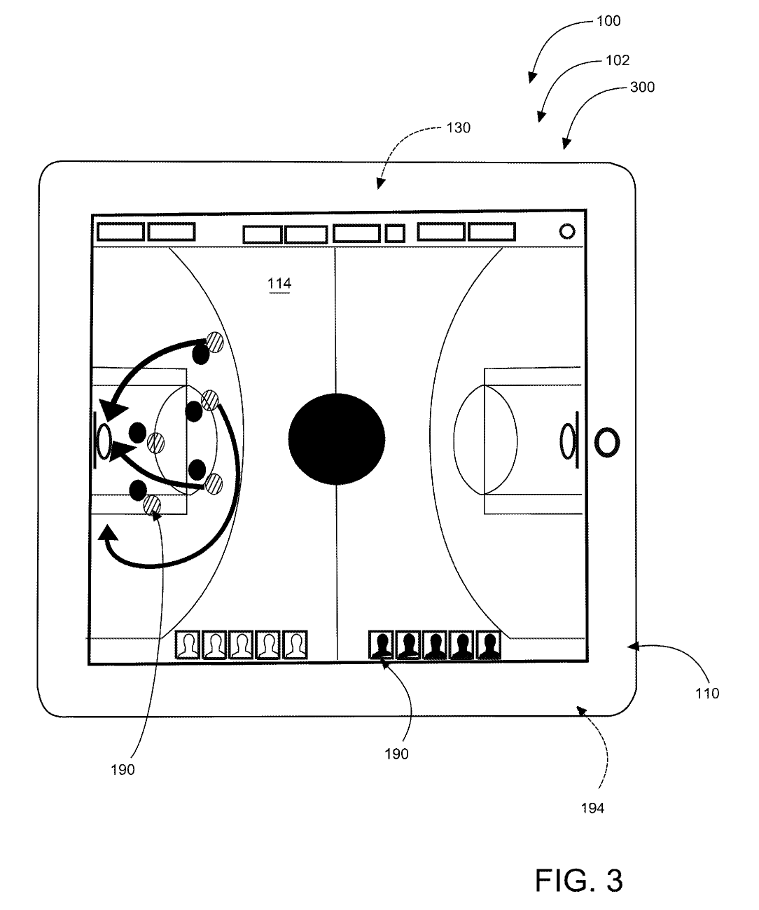

When touch screen electronic device 110 is used for the sport of (full-court) basketball 300 as shown in FIG. 3 the basketball specific sports play application 130 sports maneuver uses a full court option. Further, touch screen electronic device 110 comprises an option to draw plays for full court/field/track.

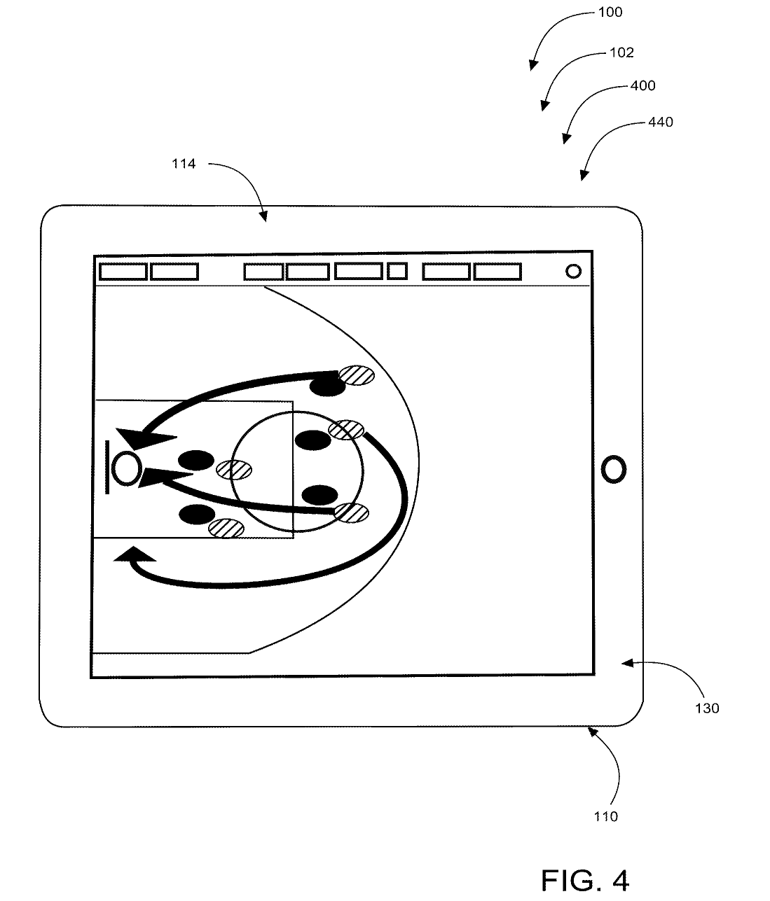

When touch screen electronic device 110 is used for the sport of half-court basketball 300 as shown in FIG. 4 the basketball specific sports play application 130 sports maneuver uses a half court option and a drawn-on review is also available for use. In this way the present invention is multi-purpose and adaptable to the games/sport being played creating a cost-effective product.

Touch screen electronic device 110 preferably allows coach-user 180 to save plays and show most-used-plays (favorites, most-effective) in ascending or descending order (as per user-preference.) Coach-user 180 when overlaying the drawn play over the video can see which player(s) 190 was out of place in the previously played sports maneuver. Touch screen electronic device 110 may save inputs for later review. Touch screen electronic device 110 preferably comprises a screen such that it is not damaged using a stylus. Sports play application preferably allows coach-user 180 to stream and record live games, as previously mentioned, such that coach-coach-user can view replays. Upon reading this specification, it should be appreciated that, under appropriate circumstances, considering such issues as coach-user preferences, design preference, structural requirements, marketing preferences, cost, available materials, technological advances, etc., other applications such as different sports or events such as, for example, soccer, baseball, tennis, hockey, and the like, etc., may be sufficient.

Coach's play system 100 according to an embodiment of the present invention of FIG. 1 may comprise kit 440. Kit 440 may comprise the following parts: touch screen electronic device 110; at least one sports play application 130 and a set of instructions. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different sports play applications, parts may be sold separately.

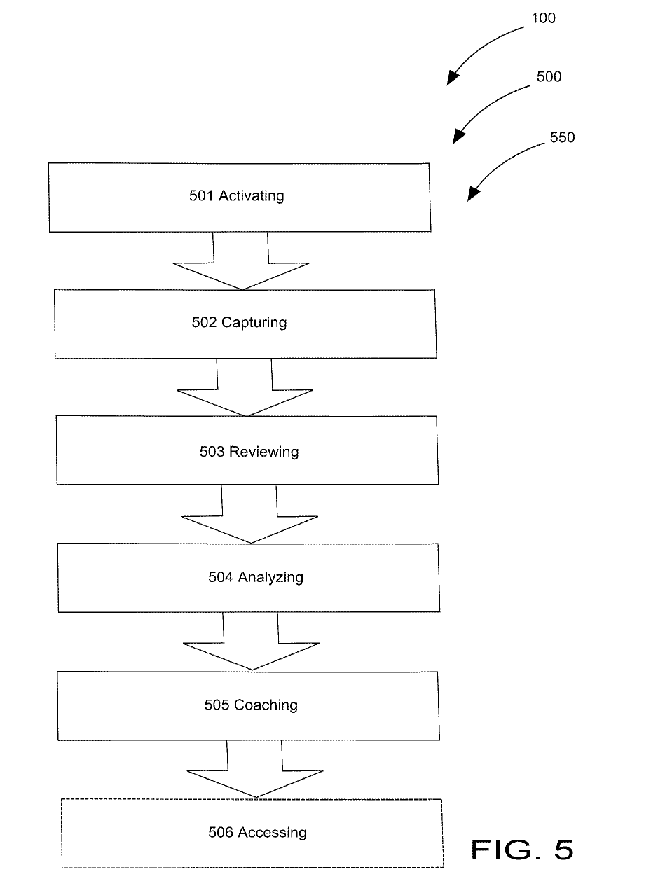

FIG. 5. shows flowchart 550 illustrating method of use 500 according to an embodiment of the present invention of FIGS. 1-4.

A method of using (at least herein enabling method of use 500) Coach's play system 100 may comprise the steps of: step one 501 activating sports play application 130 on touch screen electronic device 110; step two 502 capturing a sports maneuver; step three 503 reviewing the played sports maneuver via drawing on the touch screen electronic device; step four 504 analyzing the sports maneuver; step five 505 coaching at least one improvement on the sports maneuver; and step six 506 accessing at least one email on touch screen electronic device 110 and/or the step of accessing at least one downloadable sports video on touch screen electronic device 130.

It should be noted that step six 506 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to coach-user preference. The use of “step of” should not be interpreted as “step for”, in the claims herein and is not intended to invoke the provisions of 35 U.S.C. §112, §6. Upon reading this specification, it should be appreciated that, under appropriate circumstances, considering such issues as design preference, coach-user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A visual coaching system for sports comprising:
a touch screen electronic device; and
a sports play application; and
wherein said touch screen electronic device is portable; and
wherein said sports play application as used on said touch screen electronic device allows a coach-user to overlay a drawn play over a video such that the coach-user can review a previously played sports maneuver.

2. The visual coaching system for sports of claim 1 wherein said touch screen electronic device comprises an option that allows the coach-user to select between 1D, 2D and 3D mode(s).

3. The visual coaching system for sports of claim 1 wherein said touch screen electronic device allows the coach-user to save plays and show most-used-plays in ascending or descending order.

4. The visual coaching system for sports of claim 1 wherein said touch screen electronic device comprises an option to draw plays for half court/field/track.

5. The visual coaching system for sports of claim 1 wherein said touch screen electronic device comprises an option to draw plays for full court/field/track.

6. The visual coaching system for sports of claim 1 wherein said sports maneuver comprises a defensive-play.

7. The visual coaching system for sports of claim 1 wherein said sports maneuver comprises an offensive-play.

8. The visual coaching system for sports of claim 1 wherein said coach-user when overlaying said drawn play over said video can see which player(s) was out of place in said previously played sports maneuver.

9. The visual coaching system for sports of claim 1 wherein said touch screen electronic device further comprises a memory wherein said coach-user is able to store and retrieve created-plays therefrom.

10. The visual coaching system for sports of claim 1 wherein said sports play application allows the coach-user to coordinate team color(s) and edit numbers of said players.

11. The visual coaching system for sports of claim 10 further comprising an avatar similar to said players.

12. The visual coaching system for sports of claim 1 wherein said touch screen electronic device as connected to a communicator providing an accessible network enables the coach-user to monitor live activities of players and can send information from a first said touch screen electronic device to at least a second said touch screen electronic device.

13. The visual coaching system for sports of claim 1 wherein said touch screen electronic device is usable to inform at least one assistant about at least one situation, said coach-user able to convey a message without moving.

14. The visual coaching system for sports of claim 1 wherein said sports play application allows the coach-user to stream and record live games such that said coach-coach-user can view replays.

15. The visual coaching system for sports of claim 12 wherein said communicator providing said accessible network permits said user to receive said video via said accessible network.

16. The visual coaching system for sports of claim 12 wherein said communicator providing said accessible network permits said user to receive email via said accessible network.

17. A visual coaching system for sports comprising:
a touch screen electronic device having a memory; and
a sports play application; and
wherein said touch screen electronic device is portable and handheld;
wherein said touch screen electronic device comprises an option that allows a coach-user to select between 1D, 2D and 3D mode(s);
wherein said touch screen electronic device allows the coach-user to save plays and show most-used-plays in ascending or descending order;
wherein said touch screen electronic device comprises an option to draw plays for half and/or full court/field/track;
wherein said sports play application as used on said touch screen electronic device allows a coach-user to overlay a drawn play over a video such that the coach-user can review a previously played sports maneuver;
wherein said sports maneuver comprises defensive-plays and offensive-plays;
wherein said coach-user when overlaying said drawn play over said video can see which player(s) was out of place in said previously played sports maneuver;
wherein said memory provides that said coach-user is able to store and retrieve created-plays therefrom;
wherein said sports play application allows the coach-user to coordinate team color(s) and edit numbers of said players;
wherein said sports play application further comprising an avatar similar to said players;
wherein said touch screen electronic device when connected to a communicator provides an accessible network enabling the coach-user to monitor live activities of players and can send information from a first said touch screen electronic device to at least a second said touch screen electronic device;
wherein said touch screen electronic device is usable to inform at least one assistant about at least one situation, said coach-user able to convey a message without moving;
wherein said sports play application allows the coach-user to stream and record live games such that said coach-coach-user can view replays;
wherein said communicator providing said accessible network permits said user to receive said video via said accessible network; and
wherein said communicator providing said accessible network permits said user to receive email via said accessible network.

18. A method of using a visual coaching system for sports comprising the steps of:
activating a sports play application on a touch screen electronic device;
capturing a sports maneuver;
reviewing said played sports maneuver via drawing on said touch screen electronic device;
analyzing said sports maneuver; and
coaching at least one improvement on said sports maneuver.

19. The method of using a visual coaching system for sports of claim 18 further comprising the step of accessing at least one email on said touch screen electronic device.

20. The method of using a visual coaching system for sports of claim 18 further comprising the step of accessing at least one downloadable sports video on said touch screen electronic device.
